(19) United States
(12) Patent Application Publication
(10) Pub. No.: US 2024/0376349 A1
(43) Pub. Date: Nov. 14, 2024

(54) ADHESIVE COMPOSITIONS AND TAPES MADE THERFROM

(71) Applicant: DelStar Technologies, Inc., Alpharetta, GA (US)

(72) Inventors: Krystyna deVries, Renfrew (CA); Khizyr Khoultchaev, Branford, CT (US); Adrienne Legris, Arnprior, Ontario (CA)

(21) Appl. No.: 18/659,267

(22) Filed: May 9, 2024

Related U.S. Application Data
(60) Provisional application No. 63/501,132, filed on May 9, 2023.

(51) Int. Cl. C09J 7/38; C09J 123/28; C09J 147/00; E04D 5/14

(52) U.S. Cl. CPC C09J 7/383; C09J 123/283; C09J 147/00; E04D 5/148; C09J 2301/302; C09J 2453/00

(57) ABSTRACT

Adhesive compositions and tapes made therefrom that have improved bonding characteristics, particularly for bonding the tapes to a roofing structure, such as a roof membrane, are provided. The adhesive is chlorinated, and includes an elastomeric material. The adhesive is suitable for use on certain substrates without requiring a primer, such as thermoplastic polyolefin (TPO).

### CROSS-REFERENCE TO RELATED APPLICATIONS

This application claims the benefit of United States Provisional No. 63/501,132 filed May 9, 2023, the complete disclosure of which is incorporated herein by reference for all purposes.

### TECHNICAL FIELD

This description generally relates to adhesive compositions and tapes made therefrom. The adhesive compositions and tapes may be particularly useful for adhering to roofing materials, such as roofing materials like polyvinyl chloride (PVC), ethylene propylene diene terpolymer (EPDM), thermoplastic olefin, or thermoplastic polyolefin (TPO) roofing membranes.

### BACKGROUND

Roofing structures can comprise a variety of different materials. For example, some roofing structures can be formed of single ply sheets or membranes that are formed from suitable polymers materials, such as polyvinyl chloride (PVC), ethylene propylene diene terpolymer (EPDM), thermoplastic olefin, and thermoplastic polyolefin (TPO). This latter variety, TPO, is among one of the fastest growing commercial roofing products due to its superior performance and installation advantages. TPO roofing membranes are relatively economical, provide ease of welding for seaming and provide resistance to ultraviolet, ozone and chemical exposure.

Adhesive tapes are used in industrial applications such as in building materials as a convenient and economical manner of sealing, securing, repairing, or otherwise bonding substrates together. In many roofing systems, a cover tape is used to cover field seams, joining, and/or edge metal details like metal termination bars or drip edges prior to laying down the roofing membrane.

The adhesive cover tapes typically include a backing layer, an adhesive and a release agent or release liner. The release liner is peeled away from the adhesive and the tape is placed onto the roofing membrane such that the adhesive bonds the backing layer to the membrane. Conventional adhesives used in such tapes, however, have limited bonding characteristics that may not withstand certain environment conditions over a longer duration of time. In addition, for certain membranes, such as TPO, a primer must be applied to the membrane in order to create an effective bond between the tape and the membrane. This priming step adds time and cost to the overall installation process.

What is needed, therefore, are adhesives with improved bonding characteristics particularly for bonding a cover tape to a roofing structure, such as a single ply membrane. It would be particularly desirable to provide adhesives that may effectively bond with thermoplastic polyolefin (TPO) roofing membranes without requiring priming of the membrane prior to adhesion.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Adhesive compositions and tapes made therefrom are provided that have improved bonding characteristics, particularly for bonding the tapes to a roofing structure, such as a roof membrane.

In accordance with one aspect, an adhesive comprising an elastomeric material is provided. The adhesive may be chlorinated.

Chlorination of the adhesive increases the bonding capacity of the adhesive to certain substrates. In certain embodiments, the adhesive is configured for use with a tape, such as a pressure sensitive tape, to adhere the tape to a substrate, such as a roofing membrane or the like. The adhesive tape is suitable for use on substrates such as polyvinyl chloride (PVC), ethylene propylene diene terpolymer (EPDM), thermoplastic olefin, thermoplastic polyolefin (TPO) and the like. In one such embodiment, the substrate comprises an unprimed TPO membrane.

In certain embodiments, a separate chlorine-containing substance is included with the elastomeric material to form the adhesive. In other embodiments, the elastomeric material itself is chlorinated.

In some embodiments, the chlorine-containing substance may comprise about 2% to about 25% by weight of the adhesive, or about 5% to about 15% by weight of the adhesive.

In some embodiments, the elastomeric material may comprise about 15% to about 40% by weight of the adhesive, or about 20% to about 30% by weight of the adhesive.

Suitable materials for the chlorine-containing substance include, but are not limited to, chlorobutyl, chlorinated polyolefin, chlorinated isobutylene, chlorinated paraffins, chlorinated silicates and other fillers, chlorinated hydrocarbon resins and any combinations thereof. In one embodiment, the chlorine-containing substance comprises chlorobutyl.

In some embodiments, the adhesive has a glass transition temperature (T_{g}) of about-60 degrees Celsius to about 0 degrees Celsius. This ensures that the adhesive forms a bond between the tape and the substrate that holds properly at room temperatures.

The elastomeric material may comprise a rubber-based material, an acrylic, a polymer, such as TPO, and the like. In certain embodiments, the elastomeric material comprises a rubber-based material, such as a butyl-based material. Suitable materials for the butyl-based material include, but are not limited to, halogenated butyl rubbers, bromobutyl rubbers, chlorobutyl rubbers, halogenated isobutylene-isoprene copolymers, bromo-isobutylene-isoprene copolymers, styrene butadiene rubbers, nitrile butyl rubbers, silicone butyl rubbers, virgin butyl, butyl blends and any combinations or mixtures thereof. In one embodiment, the butyl-based material comprises a copolymer of isobutylene and isoprene.

The adhesive may further comprise a tackifier. Suitable materials for the tackifier include, but are not limited to, polybutene homopolymers, phenolic tackifier resins, non-phenolic tackifier resins and combinations thereof. In certain embodiments, the tackifier is the chlorine-containing substance. In other embodiments, the chlorine-containing substance is a separate substance mixed with the tackifier and the elastomeric material.

The adhesive may further comprise a filler. Suitable materials for the filler include, but are not limited to, expanded perlite, microspheres, expandable microspheres, ceramic spheres, zeolites, clay fillers, glass beads, hollow inorganic beads, silica type fillers, zinc oxides, glass fibers, carbon fibers, graphite fibers, silica fibers, ceramic fibers, electrically and/or thermally conducting particles, nanoparticles and any combinations thereof. In certain embodiments, the filler is the chlorine-containing substance. In other embodiments, the chlorine-containing substance is a separate substance mixed with the filler and the elastomeric material.

The adhesive may further comprise a plasticizer. Suitable materials for the plasticizer include, but are not limited to, polyisobutylene, mineral oils, tall oil resins (TOR), hydrocarbon resins, ethylene propylene diene monomer rubbers, liquid hydrocarbon resins, polybutene, polyalkylene oxides, adipic acid esters, formic acid esters, phosphoric acid esters, benzoic acid esters, phthalic acid esters, sulfonamides, naphthenic oils, and any combinations or mixtures thereof. In certain embodiments, the plasticizer is the chlorine-containing substance. In other embodiments, the chlorine-containing substance is a separate substance mixed with the plasticizer and the elastomeric material.

In accordance with another aspect, a tape comprising a first layer, a release liner removably coupled to the first layer, and an adhesive disposed between the first layer and the release liner is provided. The adhesive is a chlorinated adhesive comprising an elastomeric material.

The adhesive bonds the first layer of the tape to a roofing substrate. The roofing substrate may, for example, comprise a polyvinyl chloride (PVC), ethylene propylene diene terpolymer (EPDM) and thermoplastic polyolefin (TPO). In one embodiment, the roofing substrate comprises an unprimed thermoplastic olefin or thermoplastic polyolefin (TPO).

The first layer of the tape may comprise any suitable backing material that is generally resistant to ultraviolet, ozone and chemical exposure, such as paper, plastic, polymer, fiber, film, cloth, or metal foil. The release liner or release paper may comprise any suitable paper or plastic-based film sheet.

In accordance with another aspect, a roofing structure comprising a roof membrane, a cover tape and an adhesive bonding the cover tape to the roof membrane is provided. The adhesive is chlorinated, and comprises an elastomeric material.

In one embodiment, the roof membrane comprises an unprimed thermoplastic olefin or thermoplastic polyolefin (TPO). The tape bonds to the TPO roof membrane without the use of a primer. In certain embodiments, the tape bonds to the TPO roof membrane with at least about 10 PLI peel adhesion on a 180 degree peel test with a pull rate of 2 in/min at ambient conditions, or at least about 14 PLI peel adhesion on a 180 degree peel test with a pull rate of 2 in/min at ambient conditions.

In another embodiment, the roof membrane comprises a primed thermoplastic olefin or thermoplastic polyolefin (TPO). The tape bonds to the TPO roof membrane with at least about 20 PLI peel adhesion on a 180 degree peel test with a pull rate of 2 in/min at ambient conditions, or at least about 25 PLI peel adhesion on a 180 degree peel test with a pull rate of 2 in/min at ambient conditions.

In accordance with another aspect, a process for assembling a roofing structure is provided. The process comprises providing a roof membrane, providing a chlorinated adhesive comprising an elastomeric material, and bonding a tape to the roof membrane with the adhesive.

In certain embodiments, the roof membrane comprises a thermoplastic olefin or thermoplastic polyolefin (TPO). The adhesive bonds the tape to the roof membrane without the use of a primer with at least about 10 PLI peel adhesion on a 180 degree peel test with a pull rate of 2 in/min at ambient conditions, or at least about 14 PLI peel adhesion at ambient conditions.

In some embodiments, a cleaning agent is applied to the roof membrane before the tape is bonded to the roof membrane. Suitable cleaning agents include xylene, isopropanol (IPA) and the like.

In some embodiments, further materials are mixed into the adhesive with the elastomeric material. These materials may include tackifiers, plasticizers, fillers, curing agents, or other additives.

In certain embodiments, the adhesive comprises a separate chlorine-containing substance and the elastomeric material. In other embodiments, the adhesive comprises an elastomeric material that is chlorinated. In yet other embodiments, any of the tackifiers, plasticizers or fillers may carry the chlorine, which are then included with the elastomeric material.

The recitation herein of desirable objects which are met by various embodiments of the present description is not meant to imply or suggest that any or all of these objects are present as essential features, either individually or collectively, in the most general embodiment of the present description or in any of its more specific embodiments.

### BRIEF DESCRIPTION OF THE DRAWINGS

FIG. 1 is a schematic view of an exemplary embodiment of an adhesive tape; and

FIG. 2 is a schematic view of the adhesive tape of FIG. 1 being applied to a roof substrate.

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Adhesive compositions and tapes made therefrom are provided that have improved bonding characteristics, particularly for bonding the tapes to a roofing structure, such as a roof membrane.

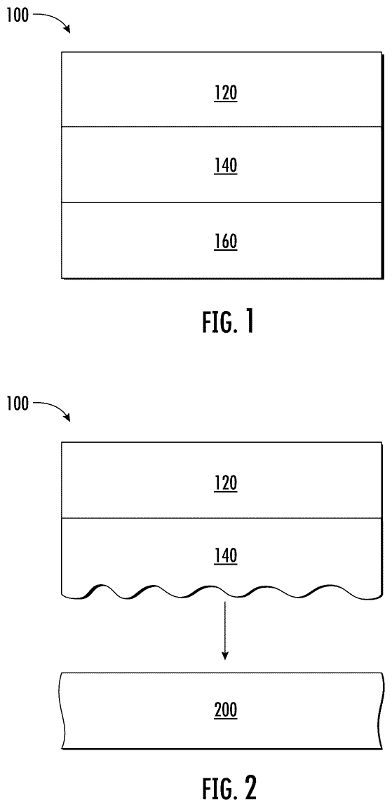

As shown in FIG. 1, a tape 100 comprises a backing layer 120 and a release liner or release paper 160. Tape 100 may comprise, for, example, a pressure-sensitive tape, that includes a pressure sensitive adhesive 140 coated onto backing layer 120. Backing layer 120 may include any suitable material that is generally resistant to ultraviolet, ozone and chemical exposure, such as paper, plastic, polymer, fiber, film, cloth, or metal foil. In one embodiment, backing layer 120 is a polymeric backing layer. Release liner 160 may comprise any suitable paper or plastic-based film sheet (usually applied during the manufacturing process) used to prevent a sticky surface from prematurely adhering. It may be on one or both sides with a release agent which provides a release effect against any type of a sticky material such as an adhesive or a mastic.

Adhesive 140 comprises an elastomeric material and is chlorinated. The chlorine-containing substance comprises about 2% to about 75% by weight of the adhesive. The chlorine is carried in a material in the range of about 2% to about 75% by weight of the adhesive. In one embodiment, the chlorine is carried in a material in the range of about 2% to 25% by weight of the adhesive, and in another embodiment, the chlorinated material is in the range of about 5% to about 15% by weight of the adhesive.

In certain embodiments, the chlorine is provided as a separate substance mixed with the elastomeric material. In other embodiments, the elastomeric material itself is chlorinated.

The presence of chlorine in the adhesive increases the bonding capacity of the adhesive to certain substrates. Suitable materials for carrying the chlorine include, but are not limited to, chlorobutyl, chlorinated polyolefin, chlorinated isobutylene, chlorinated paraffins, chlorinated silicates and other fillers, chlorinated hydrocarbon resins, and any combinations thereof. In one embodiment, the chlorine-containing substance comprises chlorobutyl.

In some embodiments, the adhesive has a glass transition temperature (T_{g}) of about-60 degrees Celsius to about 0 degrees Celsius. This ensures that the adhesive forms a bond between the tape and the substrate that holds properly at room temperatures.

The elastomeric material comprises about 15% to about 40% by weight of the adhesive, or about 20% to about 30% by weight of the adhesive. The elastomeric material may comprise a rubber-based material, an acrylic, a polymer, such as TPO, and the like.

In certain embodiments, the elastomeric material comprises a rubber-based material, such as a butyl-based material. Suitable materials for the butyl-based material include, but are not limited to, halogenated butyl rubbers, bromobutyl rubbers, chlorobutyl rubbers, halogenated isobutylene-isoprene copolymers, bromo-isobutylene-isoprene copolymers, styrene butadiene rubbers, nitrile butyl rubbers, silicone butyl rubbers, virgin butyl, butyl blends and any combinations or mixtures thereof. In one embodiment, the butyl-based material comprises a copolymer of isobutylene and isoprene.

In at least one embodiment, the adhesive may include rubber or a rubber-based material. At least a portion of the rubber or the rubber-based material may be or include halogenated rubber (e.g., chlorinated rubber) and at least a portion of the rubber or the rubber-based material may be or include non-halogenated rubber. The weight ratio of the non-halogenated rubber to the halogenated rubber may be from about 1:1 (i.e., about 1 to about 1) to about 7:1 (i.e., about 7 to about 1). For example, the weight ratio of the non-halogenated rubber to the halogenated rubber may be from about 1:1, about 1.5:1, about 2:1, about 2.5:1, about 3:1, about 3.5:1, or about 4:1 to about 4.5:1, about 5:1, about 5.5:1, about 6:1, about 6.5:1, or about 7:1. In another example, the weight ratio of the non-halogenated rubber to the halogenated rubber may be from about 1:1 to about 7:1, about 1.5:1 to about 6.5:1, about 2:1 to about 6:1, about 2.5:1 to about 5.5:1, about 3:1 to about 5:1, about 3.5:1 to about 4.5:1, or about 4:1.

The adhesive may further comprise a tackifier. Suitable materials for the tackifier include polybutene homopolymers, phenolic tackifier resins, non-phenolic tackifier resins and combinations thereof. In certain embodiments, the tackifier is chlorinated. In other embodiments, the chlorine-containing substance is a separate substance mixed with the tackifier and the elastomeric material.

The adhesive may further comprise a filler. Suitable materials for the filler include expanded perlite, microspheres, expandable microspheres, ceramic spheres, zeolites, clay fillers, glass beads, hollow inorganic beads, silica type fillers, zinc oxides, glass fibers, carbon fibers, graphite fibers, silica fibers, ceramic fibers, electrically and/or thermally conducting particles, nanoparticles and any combinations thereof. In certain embodiments, the filler is chlorinated. In other embodiments, the chlorine-containing substance is a separate substance mixed with the filler and the elastomeric material.

The adhesive may further comprise a plasticizer. Suitable materials for the plasticizer include polyisobutylene, mineral oils, tall oil resins (TOR), hydrocarbon resins, ethylene propylene diene monomer rubbers, liquid hydrocarbon resins, polybutene, polyalkylene oxides, adipic acid esters, formic acid esters, phosphoric acid esters, benzoic acid esters, phthalic acid esters, sulfonamides, naphthenic oils, and any combinations or mixtures thereof. In certain embodiments, the plasticizer is the chlorinated. In other embodiments, the chlorine-containing substance is a separate substance mixed with the plasticizer and the elastomeric material.

Referring now to FIG. 2, tape 100 may be applied to a roof structure, such as a roofing membrane 200. The roofing membrane may comprise any sheet of material used to cover a flat or low-pitched roof, for example, any suitable single-piece or single ply membrane. In certain embodiments, the membrane includes three layers (not shown): a polymer base, a polyester reinforcement scrim middle layer, and a polymer top ply, which are heat-fused at the factory. The polymer base and/or the polymer top ply may include polyvinyl chloride (PVC), ethylene propylene diene terpolymer (EPDM), thermoplastic olefin, thermoplastic polyolefin (TPO) or any other suitable polymer for use with roofing structures.

In certain embodiments, roof membrane 200 comprises an unprimed thermoplastic olefin or thermoplastic polyolefin (TPO). Tape 100 bonds to the TPO without the use of a primer. In certain embodiments, the tape bonds to the TPO with at least about 10 PLI peel adhesion on a 180 degree peel test with a pull rate of 2 in/min at ambient conditions or at least about 14 PLI peel adhesion on a 180 degree peel test with a pull rate of 2 in/min at ambient conditions.

In other embodiments, roof membrane 200 comprises a primed thermoplastic olefin or thermoplastic polyolefin (TPO). Tape 100 bonds to the TPO with at least about 20 PLI peel adhesion on a 180 degree peel test with a pull rate of 2 in/min at ambient conditions or at least about 25 PLI peel adhesion on a 180 degree peel test with a pull rate of 2 in/min at ambient conditions.

A method for forming the adhesive, the tape and the roofing structure shall now be described. The components of the adhesive are mixed together in any manner known to those skilled in the art. In one embodiment, a butyl-based elastomeric material is mixed with a chlorine-containing substance, such as chlorobutyl. Other materials, such as plasticizers, fillers, oils, additional rubbers, tackifiers and other additives (e.g., antioxidants) may be mixed with the elastomer and the chlorine-containing substance. These materials may all be mixed together in a single step, or the mixing process may include sequential steps. In one embodiment, the butyl-based elastomeric material is mixed with a chlorine-containing substance and one or more fillers in a first step and then suitable fillers, tackifiers and plasticizers are mixed in with the first set of ingredients in second or third steps.

The tape is then formed by laminating the adhesive between the backing layer and the release liner in methods known by those skilled in the art. The tape may then be applied to a roofing membrane or other structure by peeling away the release liner and adhering the backing layer 120 to the membrane.

In one embodiment, the roofing membrane comprises thermoplastic polyolefin (TPO). The surface of the TPO is thoroughly cleaned with a cleaning agent, such as xylene, isopropanol (IPA) or the like. After this cleaning step, the release layer is peeled away from the adhesive as the tape is applied to the cleaned surface of the TPO membrane.

### EXAMPLES

### Example 1

A first composition was prepared by combining the components according to Table 1. The weights, tolerances, specific gravities, and specific volumes of each component is provided.

TABLE 1

| | | | | | |
|---|---|---|---|---|---|
| | | TOLER- | | | COM- |
| | WEIGHT | ANCE | SPECIFIC | SPECIFIC | PONENT |
| DESCRIPTION | (LBS) | (+/−LBS.) | GRAVITY | VOLUME | TYPE |

MIXTURE 1

| | | | | | |
|---|---|---|---|---|---|
| Isobutylene- | 66.0 | 1.5 | 0.92 | 71.7391 | Rubber |
| isoprene | | | | | |
| copolymer | | | | | |
| butyl rubber | | | | | |
| (BUTYL 301/ | | | | | |
| BUTYL 268) | | | | | |
| Chlorinated | 14.0 | 0.5 | 0.92 | 15.2174 | Chlori- |
| copolymer of | | | | | nated |
| isobutylene & | | | | | Rubber |
| isoprene rubber | | | | | |
| (CHLORO- | | | | | |
| BUTYL | | | | | |
| 1066) | | | | | |
| Styrene- | 14.0 | 0.5 | 0.92 | 15.2174 | Rubber |
| Isoprene- | | | | | |
| Styrene block | | | | | |
| copolymer | | | | | |
| rubber | | | | | |
| (Vector | | | | | |
| 4113A) | | | | | |
| Antioxidant | 1.0 | 0.05 | 1.19 | 0.8403 | Anti- |
| (IRGANOX | | | | | oxidant |
| B 215) | | | | | |
| Aluminum | 34.0 | 0.5 | 2.6 | 13.0769 | Filler |
| silicate | | | | | |
| (WILCLAY | | | | | |
| SA-1 | | | | | |
| KAOLIN | | | | | |
| CLAY) | | | | | |

MIXTURE 2

| | | | | | |
|---|---|---|---|---|---|
| Zinc oxide | 5.0 | 0.5 | 5.61 | 0.8913 | Filler |
| (ZINC | | | | | |
| OXIDE 104 | | | | | |
| KADOX-920 | | | | | |
| (PC 216) | | | | | |
| Aluminum | 50.0 | 1 | 2.6 | 19.2308 | Filler |
| silicate | | | | | |
| (WILCLAY | | | | | |
| SA-1 | | | | | |
| KAOLIN | | | | | |
| CLAY) | | | | | |
| Toll oil Resin | 5.0 | 0.5 | 1.06 | 4.7170 | Tackifier |
| (SYLVAROS | | | | | |
| PR295) | | | | | |
| Thermoplastic | 3.0 | 0.5 | 1.05 | 2.8571 | Tackifier |
| Aromatic | | | | | |
| hydrocarbon | | | | | |
| resin | | | | | |
| (ENDEX 155) | | | | | |
| Polybutene | 26.0 | 0.5 | 0.89 | 29.2135 | Plasti- |
| polymer | | | | | cizer |
| (POLY- | | | | | |
| BUTENE24/ | | | | | |
| INDOPOLH | | | | | |
| 100/TCP 1105) | | | | | |
| Aliphatic | 50.0 | 1 | 0.96 | 52.0833 | Tackifier |
| hydrocarbon | | | | | |
| C5 resin | | | | | |
| (ESCOREZ | | | | | |
| 1310) | | | | | |

Mixture 1 was prepared by mixing the rubber components: (1) isobutylene-isoprene copolymer butyl rubber (e.g., Butyl 301/Butyl 268 commercially available from Lanxess of Cologne, Germany) and (2) styrene-isoprene-styrene block copolymer rubber (e.g., Vector 4113A commercially available from TSRC Corporation); the chlorinated copolymer of isobutylene & isoprene rubber (e.g., CHLOROBUTYL 1066 commercially available from ExxonMobil of Houston, Texas); the an antioxidant (e.g., IRGANOX® B 215 commercially available from BASF of Ludwigshafen, Germany); and the aluminum silicate filler (e.g., WILCLAY SA-1 KAOLIN CLAY commercially available from Active Minerals). Mixture 1 was mixed for about 2 minutes and 30 seconds at a speed of 45 RPM.

Mixture 2 was prepared by mixing the fillers: zinc oxide (e.g., KADOX-920 commercially available from Zochem of Ontario, Canada) and aluminum silicate (e.g., WILCLAY SA-1 KAOLIN CLAY commercially available from Active Minerals); the tackifiers: toll oil resin (e.g., SYLVAROS™ PR295 commercially available from Kraton of The Woodlands, Texas); the aliphatic hydrocarbon C5 resin (ESCOREZ™ 1310 commercially available from ExxonMobil of Houston, Texas), and the thermoplastic aromatic hydrocarbon resin (e.g., ENDEX 155 commercially available from Downers Grove, Illinois); and the plasticizer: polybutylene polymer(s) (e.g., POLYBUTENE24/INDOPOLH100/TCP 1105 commercially available from Soltex, Inc. of The Woodlands, Texas). Particularly, the zinc oxide, the toll oil resin, about half of the aluminum silicate, and about 10 lbs of the polybutene polymer were contacted with Mixture 1 and mixed for about 4 minutes at about 45 RPM. The remaining components, except the aliphatic hydrocarbon C5 resin, were subsequently contacted or combined with the mixture and mixed for about 2.5 minutes at about 110 RPM. The aliphatic hydrocarbon C5 resin was then combined with the mixture to prepare the first composition.

### Example 2

A second composition was prepared by combining the components according to Table 2. The weights, tolerances, specific gravities, and specific volumes of each component is provided.

TABLE 2

| | | | | | |
|---|---|---|---|---|---|
| | | | SPE- | SPE- | |
| | | TOLER- | CIFIC | CIFIC | COM- |
| | WEIGHT | ANCE | GRAV- | VOL- | PONENT |
| DESCRIPTION | (LBS) | (+/−LBS.) | ITY | UME | TYPE |

MIXTURE 1

| | | | | | |
|---|---|---|---|---|---|
| Isobutylene- | 52.0 | 1.5 | 0.92 | 56.5217 | Rubber |
| isoprene | | | | | |
| copolymer | | | | | |
| butyl rubber | | | | | |
| (BUTYL 301/ | | | | | |
| BUTYL 268) | | | | | |
| Chlorinated | 28.0 | 0.5 | 0.92 | 30.4348 | Chlori- |
| copolymer of | | | | | nated |
| isobutylene & | | | | | Rubber |
| isoprene rubber | | | | | |
| (CHLORO- | | | | | |
| BUTYL | | | | | |
| 1066) | | | | | |
| Styrene- | 14.0 | 0.5 | 0.92 | 15.2174 | Rubber |
| Isoprene- | | | | | |
| Styrene block | | | | | |
| copolymer | | | | | |
| rubber | | | | | |
| (Vector 4113A) | | | | | |
| Antioxidant | 1.0 | 0.05 | 1.19 | 0.8403 | Anti- |
| (IRGANOX | | | | | oxidant |
| B 215) | | | | | |
| Aluminum | 34.0 | 0.5 | 2.6 | 13.0769 | Filler |
| silicate | | | | | |
| (WILCLAY | | | | | |
| SA-1 | | | | | |
| KAOLIN | | | | | |
| CLAY) | | | | | |

MIXTURE 2

| | | | | | |
|---|---|---|---|---|---|
| Zinc oxide | 5.0 | 0.5 | 5.61 | 0.8913 | Filler |
| (ZINC | | | | | |
| OXIDE 104 | | | | | |
| KADOX- | | | | | |
| 920(PC 216) | | | | | |
| Aluminum | 50.0 | 1 | 2.6 | 19.2308 | Filler |
| silicate | | | | | |
| (WILCLAY | | | | | |
| SA-1 | | | | | |
| KAOLIN | | | | | |
| CLAY) | | | | | |
| Toll oil Resin | 5.0 | 0.5 | 1.06 | 4.7170 | Tackifier |
| (SYLVAROS | | | | | |
| PR295) | | | | | |
| Thermoplastic | 3.0 | 0.5 | 1.05 | 2.8571 | Tackifier |
| Aromatic | | | | | |
| hydrocarbon | | | | | |
| resin | | | | | |
| (ENDEX 155) | | | | | |
| Polybutene | 26.0 | 0.5 | 0.89 | 29.2135 | Plasti- |
| polymer | | | | | cizer |
| (POLY- | | | | | |
| BUTENE24/ | | | | | |
| INDOPOLH100/ | | | | | |
| TCP 1105) | | | | | |
| Aliphatic | 50.0 | 1 | 0.96 | 52.0833 | Tackifier |
| hydrocarbon | | | | | |
| C5 resin | | | | | |
| (ESCOREZ | | | | | |
| 1310) | | | | | |

Mixture 1 was prepared by mixing the rubber components: (1) isobutylene-isoprene copolymer butyl rubber (e.g., Butyl 301/Butyl 268 commercially available from Lanxess of Cologne, Germany) and (2) styrene-isoprene-styrene block copolymer rubber (e.g., Vector 4113A commercially available from TSRC Corporation); the chlorinated copolymer of isobutylene & isoprene rubber (e.g., CHLOROBUTYL 1066 commercially available from ExxonMobil of Houston, Texas); the an antioxidant (e.g., IRGANOX® B 215 commercially available from BASF of Ludwigshafen, Germany); and the aluminum silicate filler (e.g., WILCLAY SA-1 KAOLIN CLAY commercially available from Active Minerals). Mixture 1 was mixed for about 2 minutes and 30 seconds at a speed of 45 RPM, starting at about 40 RPM.

Mixture 2 was prepared by mixing the fillers: zinc oxide (e.g., KADOX-920 commercially available from Zochem of Ontario, Canada) and aluminum silicate (e.g., WILCLAY SA-1 KAOLIN CLAY commercially available from Active Minerals); the tackifiers: toll oil resin (e.g., SYLVAROS™ PR295 commercially available from Kraton of The Woodlands, Texas); the aliphatic hydrocarbon C5 resin (ESCOREZ™ 1310 commercially available from ExxonMobil of Houston, Texas), and the thermoplastic aromatic hydrocarbon resin (e.g., ENDEX 155 commercially available from Downers Grove, Illinois); and the plasticizer: polybutylene polymer(s) (e.g., POLYBUTENE24/INDOPOLH100/TCP 1105 commercially available from Soltex, Inc. of The Woodlands, Texas). Particularly, the zinc oxide, the toll oil resin, about half of the aluminum silicate, and about 10 lbs of the polybutene polymer were contacted with Mixture 1 and mixed for about 4 minutes at about 45 RPM. The remaining components, except the aliphatic hydrocarbon C5 resin, were subsequently contacted or combined with the mixture and mixed for about 2.5 minutes at about 110 RPM. The aliphatic hydrocarbon C5 resin was then combined with the mixture to prepare the second composition.

### Example 3

A third composition was prepared by combining the components according to Table 3. The weights, tolerances, specific gravities, and specific volumes of each component is provided.

TABLE 3

| | | | | | |
|---|---|---|---|---|---|
| | | | SPE- | SPE- | |
| | | TOLER- | CIFIC | CIFIC | COM- |
| | WEIGHT | ANCE | GRA- | VOL- | PONENT |
| DESCRIPTION | (LBS) | (+/−LBS.) | VITY | UME | TYPE |

MIXTURE 1

| | | | | | |
|---|---|---|---|---|---|
| Isobutylene- | 52.0 | 1.5 | 0.92 | 56.5217 | Rubber |
| Isoprene | | | | | |
| Copolymer | | | | | |
| Butyl Rubber | | | | | |
| (BUTYL 301/ | | | | | |
| BUTYL 268) | | | | | |
| Chlorinated | 28.0 | 0.5 | 0.92 | 30.4348 | Chlori- |
| Copolymer of | | | | | nated |
| Isobutylene & | | | | | Rubber |
| Isoprene Rubber | | | | | |
| (CHLORO- | | | | | |
| BUTYL | | | | | |
| 1066) | | | | | |
| Styrene-Isoprene- | 14.0 | 0.5 | 0.92 | 15.2174 | Rubber |
| Styrene block | | | | | |
| Copolymer | | | | | |
| Rubber | | | | | |
| (Vector 4113A) | | | | | |
| Antioxidant | 1.0 | 0.05 | 1.19 | 0.8403 | Anti- |
| (IRGANOX | | | | | oxidant |
| B 215) | | | | | |
| Aluminum | 34.0 | 0.5 | 2.6 | 13.0769 | Filler |
| Silicate | | | | | |
| (WILCLAY SA-1 | | | | | |
| KAOLIN CLAY) | | | | | |

MIXTURE 2

| | | | | | |
|---|---|---|---|---|---|
| Zinc Oxide | 5.0 | 0.5 | 5.61 | 0.8913 | Filler |
| (ZINC OXIDE | | | | | |
| 104 | | | | | |
| KADOX-920 | | | | | |
| (PC 216) | | | | | |
| Aluminum | 25.0 | 0.5 | 2.6 | 9.6154 | Filler |
| Silicate | | | | | |
| (WILCLAY SA-1 | | | | | |
| KAOLIN CLAY) | | | | | |
| Titanium Dioxide | 20.0 | 0.5 | 4 | 1.2500 | Filler |
| (KRONOS 2310) | | | | | |
| Aliphatic C-5 | 6.0 | 0.5 | 0.92 | 6.5217 | Tackifier |
| Petroleum | | | | | |
| Hydrocarbon | | | | | |
| Resin | | | | | |
| (WINGTAC 10/ | | | | | |
| PICCOTAC 1020 | | | | | |
| ADTAC LV) | | | | | |
| Toll Oil Resin | 5.0 | 0.5 | 1.06 | 4.7170 | Tackifier |
| (SYLVAROS | | | | | |
| PR295) | | | | | |
| Thermoplastic | 3.0 | 0.5 | 1.05 | 2.8571 | Tackifier |
| Aromatic | | | | | |
| Hydrocarbon | | | | | |
| Resin | | | | | |
| (ENDEX 155) | | | | | |
| Polybutene | 26.0 | 0.5 | 0.89 | 29.2135 | Plasti- |
| Polymer | | | | | |
| (POLY- | | | | | cizer |
| BUTENE24/ | | | | | |
| INDOPOLH100/ | | | | | |
| TCP 1105) | | | | | |
| Aliphatic | 50.0 | 1 | 0.96 | 52.0833 | Tackifier |
| Hydrocarbon | | | | | |
| C5 Resin | | | | | |
| (ESCOREZ 1310) | | | | | |

Mixture 1 was prepared by mixing the rubber components: (1) isobutylene-isoprene copolymer butyl rubber (e.g., Butyl 301/Butyl 268 commercially available from Lanxess of Cologne, Germany) and (2) styrene-isoprene-styrene block copolymer rubber (e.g., Vector 4113A commercially available from TSRC Corporation); the chlorinated copolymer of isobutylene & isoprene rubber (e.g., CHLOROBUTYL 1066 commercially available from ExxonMobil of Houston, Texas); the an antioxidant (e.g., IRGANOX® B 215 commercially available from BASF of Ludwigshafen, Germany); and the aluminum silicate filler (e.g., WILCLAY SA-1 KAOLIN CLAY commercially available from Active Minerals). Mixture 1 was mixed for about 2 minutes and 30 seconds at a speed of 45 RPM.

Mixture 2 was prepared by mixing the fillers: zinc oxide (e.g., KADOX-920 commercially available from Zochem of Ontario, Canada), the aluminum silicate (e.g., WILCLAY SA-1 KAOLIN CLAY commercially available from Active Minerals), and the titanium dioxide (e.g., KRONOS 2310 commercially available from Kronos of Leverkusen, Germany); the tackifiers: aliphatic C-5 petroleum hydrocarbon resins (e.g., WINGTACK® 10 commercially available from Cray Valley/TotalEnergies of Houston, Texas, PICCOTAC 1020 commercially available from Eastman of Kingsport, Tennessee, and ADTAC LV commercially available from Ashland Inc. of Wilmington, DE), toll oil resin (e.g., SYLVAROS™ PR295 commercially available from Kraton of The Woodlands, Texas); the aliphatic hydrocarbon C5 resin (ESCOREZ™ 1310 commercially available from ExxonMobil of Houston, Texas), and the thermoplastic aromatic hydrocarbon resin (e.g., ENDEX 155 commercially available from Downers Grove, Illinois); and the plasticizer: polybutylene polymer(s) (e.g., POLYBUTENE24/INDOPOLH100/TCP 1105 commercially available from Soltex, Inc. of The Woodlands, Texas). Particularly, the zinc oxide, the toll oil resin, about half of the aluminum silicate, and about 10 lbs of the polybutene polymer were contacted with Mixture 1 and mixed for about 4 minutes at about 45 RPM. The remaining components, except the aliphatic hydrocarbon C5 resins (e.g., the WINGTACK 10, the PICCOTAC 1020, the ADTAC LV, and the ESCOREZ 1310), were subsequently contacted or combined with the mixture and mixed for about 2.5 minutes at about 110 RPM. The aliphatic hydrocarbon C5 resins were then combined with the mixture to prepare the third composition.

### Example 4

Adhesive testing was performed on the adhesive compositions to compare the pull strength required to separate the tape from the substrate (TPO). Particularly, adhesive testing was conducted on the first composition, the second composition, and the third composition of Example 1, Example 2, and Example 3, respectively, to evaluate the pull strength to separate the tape from a TPO substrate. These tests were performed under the following standards: (1) Pressure Sensitive Tape Council (PSTC) 101-Peel Adhesion of Pressure Sensitive Tapes; (2) European Adhesive Tape Association (AFERA) 5001-Measurement of Peel Adhesion of Adhesive Tapes ISO 2986; and (3) ASTM D100-Standard Test Methods for Pressure-Sensitive Tapes.

In a first test, various adhesives were subjected to a 180-degree peel at 12 inches per minute under ambient conditions. In this test, the substrate was a TPO roof membrane that was primed and uncleaned. As shown below in Table 4, the tapes including adhesive as described herein and in Example 1 (designated in the table as “Test Sample”), performed substantially better than the control samples (designated in the table as “Control Sample”). The tape described herein bonded to the TPO with a 25.98 PLI peel adhesion (lbs/inch) on a 180 degree peel test with a pull rate of 12 in/min at ambient conditions, whereas the control samples only bonded with 8.91 and 17.29 PLI peel adhesions.

TABLE 4

| | | Adhesion to | |
|---|---|---|---|
| | | Primed, | |
| | | Uncleaned | |
| | | TPO Roofing | |
| | | (lbs/in) | Comments/ |
| Sample | Primed Substrate | (12 in/min) | Observations |
| Control | Primed roofing | 8.91 | Peeled primer off |
| | membrane with | | TPO—stick slip |
| | GAF primer | | |
| Sample | Primed DM | 17.29 | Peeled primer off |
| | | | TPO—stick slip |
| Test | Primed roofing | 25.98 | Adhesion so high, |
| Sample | membrane with | | it was stretching |
| | GAF primer | | the DM |

### Example 5

Additional testing was performed on unprimed, uncleaned PTO roofing membrane material, again employing the 180-degree peel at 12 inches per minute. As shown below in Table 5, the adhesive mixed as per the above Example 1 (designated in the table as “Test Sample”) performed substantially better than various other test subjects (designated in the table as “Control Sample”, with additional additives), for adhesion to unprimed, uncleaned thermoplastic polyolefin roofing membrane material. The tape/adhesive described herein bonded to the TPO with a 2.75 PLI peel adhesion (lbs/inch) on a 180 degree peel test with a pull rate of 12 in/min at ambient conditions.

TABLE 5

| | Adhesion to | | |
|---|---|---|---|
| | Unprimed, | Max | |
| | Uncleaned TPO | Adhesion | |
| | Roofing (lbs/in) | Peaks | Comments/ |
| Mix # | (12 in/min) | (lbs/in) | Observations |
| Control Sample | 0.84 | n/a—max | Clean peel |
| | | peak is the | |
| | | adhesion | |
| | | level as it | |
| | | was clean peel | |
| Additive Level 1 | 2.32 | 3.0 | Stick slip |
| Additive Level 2 | 1.96 | 2.9 | Stick slip |
| Additive Level 3 | 1.81 | 3.0 | Stick slip |
| Test Sample | 2.75 | 4.0 | Stick slip |

### Example 6

Still additional testing was performed on unprimed, uncleaned PTO roofing membrane material, this time employing a 2 inches per minute peel test. As shown below in Table 6, the adhesive mixed as per the above Example 1 (designated in the table as “Test Sample”) performed substantially better than various other test subjects (designated in the table as “Control Sample”, with additional additives), for adhesion to unprimed, uncleaned thermoplastic polyolefin roofing membrane material. The tape/adhesive described herein bonded the TPO with an 8.85 PLI peel adhesion (lbs/inch) on a 180 degree peel test with a pull rate of 2 in/min at ambient conditions.

TABLE 6

| | Adhesion to | | |
|---|---|---|---|
| | Unprimed, | | |
| | Uncleaned | Max | |
| | TPO Roofing | Adhesion | |
| | (lbs/in) | Peaks | Comments/ |
| Mix # | (2 in/min) | (lbs/in) | Observations |
| Mixing Control | 5.13 | 13 | Virtually all clean peel |
| | | | (3% cohesive split) |
| Additive Level 1 | 3.94 | 7.0 | Intermittent cohesive |
| | | | failure (but then released) |
| Additive Level 2 | 1.04 | 2.9 | Clean peel |
| Additive Level 3 | 0.94 | 1.7 | Clean peel |
| Test Sample | 8.85 | 15.0 | 50% cohesive split, but |
| | | | then peeled off |

### Example 7

Finally, still further testing was performed, this time on unprimed, but cleaned (specifically with 99% IPA prior to applying the tape) PTO roofing membrane material, again employing a 2 inches per minute peel test. As shown below in Table 7, the adhesive mixed as per the above Example 1 (designated in the table as “Test Sample”) performed substantially better than various other test subjects (designated in the table as “Control Sample”, with additional additives), for adhesion to unprimed, uncleaned thermoplastic polyolefin roofing membrane material. The tape/adhesive described herein bonded the TPO with a 14.24 PLI peel adhesion (lbs/inch) on a 180 degree peel test with a pull rate of 2 in/min at ambient conditions.

TABLE 7

| | Adhesion to | | |
|---|---|---|---|
| | Unprimed, | | |
| | Cleaned* | Max | |
| | TPO Roofing | Adhesion | |
| | (lbs/in) | Peaks | Comments/ |
| Mix # | (2 in/min) | (lbs/in) | Observations |
| Control Sample | 5.41 | 5.5 | Clean peel—stick slip |
| Additive Level 1 | 17.98 | n/a | 50-60% cohesive split |
| Additive Level 2 | 15.69 | n/a | 100% cohesive failure |
| Additive Level 3 | 3.52 | n/a | Clean peel, started to |
| | | | cohesive split at end |
| Test Sample | 14.24 | n/a | 100% cohesive split |

*surface cleaned with 99% IPA prior to applying tape

Thus, the adhesive samples described herein provided improved bonding to TPO substrates than the control samples when the TPO substrates were primed, unprimed and unprimed and uncleaned.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

What is claimed is:

1. An adhesive comprising:
an elastomeric material,
wherein the adhesive is chlorinated.

2. The adhesive of claim 1, wherein the elastomeric material comprises a rubber-based material, an acrylic, a polymeric material, or a thermoplastic polyolefin.

3. The adhesive of claim 2, wherein the rubber-based material comprises a butyl-based material.

4. The adhesive of claim 3, wherein the butyl-based material comprises a material selected from the group consisting of halogenated butyl rubbers, bromobutyl rubbers, chlorobutyl rubbers, halogenated isobutylene-isoprene copolymers, bromo-isobutylene-isoprene copolymers, styrene butadiene rubbers, nitrile butyl rubbers, silicone butyl rubbers, virgin butyl, butyl blends, and any combinations or mixtures thereof.

5. The adhesive of claim 4, wherein the butyl-based material comprises a copolymer of isobutylene and isoprene.

6. The adhesive of claim 1, wherein the elastomeric material is about 15% to about 40% by weight of the adhesive.

7. The adhesive of claim 1, wherein the elastomeric material is chlorinated.

8. The adhesive of claim 1, further including a chlorine-containing substance.

9. The adhesive of claim 8, wherein the chlorine-containing substance comprises a material selected from the group consisting of chlorobutyl, chlorinated polyolefin, chlorinated isobutylene, chlorinated paraffins, chlorinated silicates and other fillers, chlorinated hydrocarbon resins, and any combinations thereof.

10. The adhesive of claim 9, wherein the chlorine-containing substance comprises chlorobutyl.

11. The adhesive of claim 1, wherein the chlorine is carried in a material in the range of about 2% to about 75% by weight of the adhesive.

12. The adhesive of claim 1, wherein the adhesive has a glass transition temperature (T_{g}) of about-60 degrees Celsius to about 0 degrees Celsius.

13. The adhesive of claim 1, further comprising a tackifier.

14. The adhesive of claim 13, wherein the tackifier is chlorinated.

15. The adhesive of claim 13, wherein the tackifier comprises a material selected from the group consisting of a polybutene homopolymer, a phenolic tackifier resin, a non-phenolic tackifier resin and combinations thereof.

16. The adhesive of claim 1, further comprising a filler.

17. The adhesive of claim 16, wherein the filler is chlorinated.

18. The adhesive of claim 16, wherein the filler comprises a material selected from the group consisting of expanded perlite, microspheres, expandable microspheres, ceramic spheres, zeolites, clay fillers, glass beads, hollow inorganic beads, silica type fillers, glass fibers, carbon fibers, graphite fibers, zinc oxides, silica fibers, ceramic fibers, electrically and/or thermally conducting particles, nanoparticles, and any combinations thereof.

19. The adhesive of claim 1, further comprising a plasticizer.

20. The adhesive of claim 19, wherein the plasticizer is chlorinated.

21. The adhesive of claim 19, wherein the plasticizer comprises a material selected from the group consisting of polyisobutylene, mineral oils, tall oil resins (TOR), hydrocarbon resins, ethylene propylene diene monomer rubbers, liquid hydrocarbon resins, polybutene, polyalkylene oxides, adipic acid esters, formic acid esters, phosphoric acid esters, benzoic acid esters, phthalic acid esters, sulfonamides, naphthenic oils, and any combinations or mixtures thereof.

22. The adhesive of claim 1, wherein the adhesive is a pressure sensitive adhesive (PSA).

23. The adhesive of claim 22, further being configured for use on a substrate comprising polyvinyl chloride (PVC), an ethylene propylene diene terpolymer (EPDM), a thermoplastic olefin, or a thermoplastic polyolefin (TPO).

24. The adhesive of claim 23, wherein the substrate comprises an unprimed thermoplastic polyolefin.

25. A tape, comprising:
a first layer;
a release liner removably coupled to the first layer; and
the adhesive of claim 1 disposed between the first layer and the release liner.

26. A roofing structure, comprising:
a roof membrane;
a tape; and
the adhesive of claim 1 bonding the tape of the roof membrane.

27. A roofing structure assembled by a process comprising:
providing a roof membrane;
providing the adhesive of claim 1; and
bonding a tape to the roof membrane with the adhesive.
